(19) United States
(12) Patent Application Publication
(10) Pub. No.: US 2003/0054864 A1
(43) Pub. Date: Mar. 20, 2003

(54) Method and apparatus for defining a telephone call handling profile and handling a call using the same

(76) Inventor: Iwo-Martin Mergler, South Hampton (GB)

Correspondence Address: PHILIPS ELECTRONICS NORTH AMERICAN CORP, 580 WHITE PLAINS RD, TARRYTOWN, NY, 10591, US

(21) Appl. No.: 10/228,560

(22) Filed: Aug. 27, 2002

(30) Foreign Application Priority Data
Sep. 15, 2001 (GB) 0122360.1

(51) Int. Cl. H04M 1/00; H04B 1/38

(52) U.S. Cl. 455/566; 455/567

(57) ABSTRACT

A method of enabling a user to define a call handling profile for a telephone is disclosed. The method comprising the steps of presenting on the telephone display (14) a plurality of groups of telephone numbers, or identifiers associated therewith, for selection (22) of at least one of them by the user; presenting on the telephone display a plurality of rules for handling incoming calls for selection of at least one of them by the user; and associating the or each group selected by the user with the or each rule selected by the user to define the profile.

Also disclosed is a method of handling a call made to a telephone (10) wherein such a call handling profile has been defined, and corresponding telephone and communications system for the same.

### FIELD OF INVENTION

This invention relates to a method of enabling a user of a telephone to define a call handling profile for that telephone, to a method of handling a call made to a telephone wherein such a call handling profile has been defined, and to a corresponding telephone and communications system for the same.

### BACKGROUND TO INVENTION

It is increasingly commonplace for mobile cellular telephone manufacturers and telephone network operators to offer call handling functions to a subscriber or user of a mobile telephone such as call forwarding, international call barring and divert to voicemail. It is also known for a mobile telephone to offer to a user other options relating to incoming calls including enabling the user to select a ringtone melody from a predefined list of ringtones and to select the ringtone volume level. Combinations of network and user defined settings relating to a user's mobile telephone are said to define a personal call handling profile for that telephone and such profiles prove popular with mobile telephone subscribers in that a certain degree of user personalisation of their telephone is enabled.

Anonymously disclosed article 438021 published in the October 2000 issue of Research Disclosure (page 1733) discloses a method for automatically changing such a profile in a cellular telephone based on its detected location. In particular, it discloses that a user may define a profile of particular settings associated with a location and wherein, upon detection of the location by the mobile telephone, those settings would be activated.

### OBJECT OF INVENTION

It is an object of the present invention to provide an improved method of enabling a user to define a call handling profile for a telephone.

### SUMMARY OF INVENTION

According to the present invention, there is provided such a method, comprising the steps of presenting a plurality of groups of telephone numbers, or identifiers associated therewith, for selection of at least one of them by the user; presenting a plurality of rules for handling incoming calls for selection of at least one of them by the user; and associating the or each group selected by the user with the or each rule selected by the user to define the profile.

Further in accordance with the present invention, handling of a call made to a telephone for which such a profile has been defined may be implemented by determining whether the incoming call has a telephone number which exists within a group within said profile; and handling the call in accordance with the or each associated rule.

The present invention enables a user of a telephone to define a call handling profile by groups. For example, a user who has grouped contacts of his/her telephone's “phonebook” into “family” and “friends” groups may assign different ringtones for each group. In this case, the user is then able to aurally distinguish which type of person, i.e. friend or family, is making an incoming call. Alternatively, the groups may be predefined by the manufacturer of the telephone. The groups may also be defined negatively, for example, a group defined as those other in the group “family”.

An additional benefit of the present invention is that the association of a rule with a group of potential callers enables a user to alter a call handling rule for many callers with a minimum of input effort.

A profile defined by associating groups and rules on a user's telephone may be subsequently relayed to a remote server associated with a switching centre or other apparatus operated by a telephone network operator. This would allow network operators to implement particular types of call handling which might not be possible to do in the user's telephone alone, and may include call barring or diverting, message (e.g. SMS) handling and voice mail. For example, a user may define a profile whereby all incoming calls from members of a “business” group containing the numbers of work colleagues are diverted to voicemail at the weekend. This profile may be subsequently uploaded to the telephone network operator for implementation of the call diversion.

It may well be most convenient if a profile is defined by a user on the telephone for which the profile is intended (and automatically related thereto). However, it may be convenient to define a profile on a computer and upload it directly to either a telephone network operator, a user's telephone or both. This arrangement would enable a user to update and backup their mobile phone profile from various locations whether they have their mobile telephone with them or not.

Yet further provided in accordance with the present invention is a corresponding telephone and communications system as claimed in the claims, the disclosure of which is incorporated herein by reference, and to which the reader is now directed.

### BRIEF DESCRIPTION OF DRAWINGS

Preferred embodiments of the invention will now be described, by way of example only, with reference to the accompanying drawings in which:

FIG. 1a shows a front view of a mobile cellular telephone according to the present invention;

FIG. 1b shows, schematically, the internal components of the telephone of FIG. 1a;

FIG. 2a illustrates a database stored in the memory of the telephone of FIG 1a;

FIGS. 2b and 2c each show a display of the mobile telephone;

FIG. 3 is a flow diagram illustrating a method of call handling according to the present invention; and

FIG. 4 shows, schematically, a communications system according to the present invention.

In the figures the same reference numerals have been used to indicate corresponding features.

### DETAILED DESCRIPTION

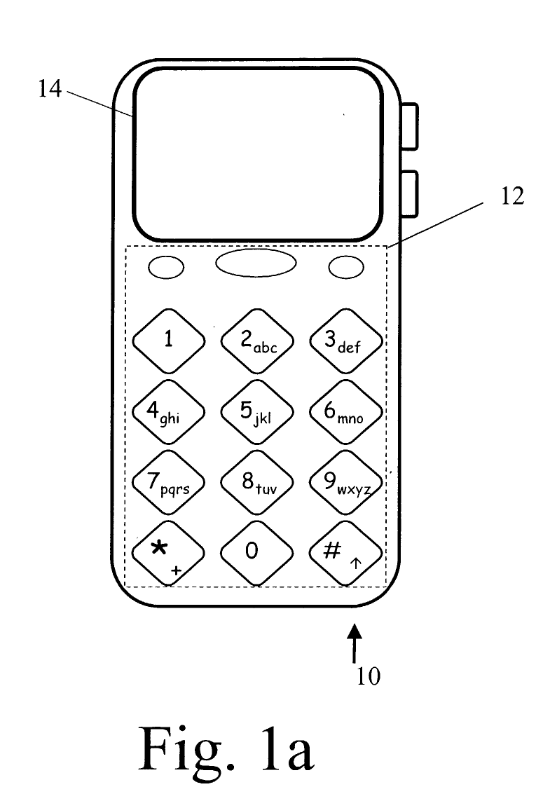

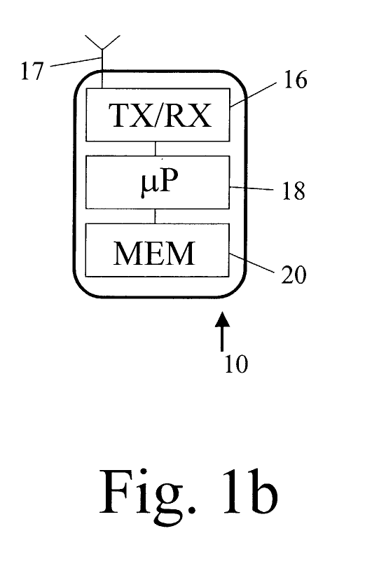

FIG. 1a shows a front view of a mobile telephone 10 having a user interface suitable for implementing the present invention and including a keypad 12 and a display 14.

FIG. 1b shows, schematically, the internal components of the telephone 10 relevant to the present invention. The components include transmitter and receiver circuitry 16 coupled to an antenna 17, and controlled by a microprocessor 18 which is connected to a memory 20. Software provided in the memory in conjunction with the microprocessor controls the telephone 10 in order to make and receive calls, display information on the display 14 and enables the user to interact with the telephone via the keypad 12 and other standard interface elements such as a microphone and speaker (not shown). The design and manufacturing of such telephones for two-way communication within a cellular telephone network are well known and, as such, those parts which do not form part of the present invention will not be elaborated upon here further.

In the memory 20, a database of names and telephone numbers known to the user, i.e. the user's “phonebook”, is stored having previously been entered by the user.

In accordance with the present invention, the microprocessor 18 and software stored in the memory 20 are configured to enable a user of the telephone to define a call handling profile for that telephone whereby the user is able to define the profile by associating groups of telephone numbers, or identifiers associated therewith such as name tags, with rules for handling incoming calls. This may be done in accordance with either of the following examples:

### EXAMPLE 1

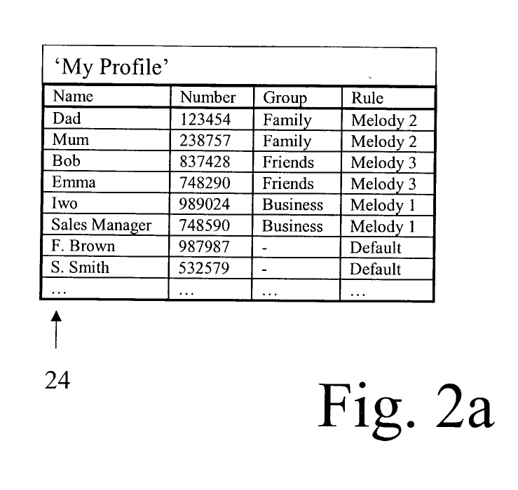

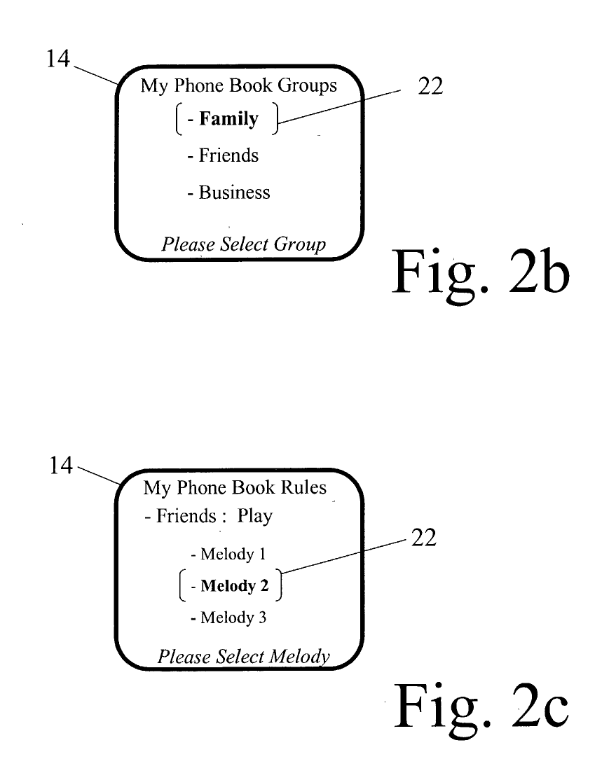

In a conventional manner, a user defines contacts in his/her telephone's phonebook by “Name” and “Number” (telephone number) as illustrated by columns 1 and 2 of the phonebook database (24) of FIG. 2a. Then, in order to define a call handling profile, the telephone displays to the user those groups, as shown in FIG. 2b, which in this example are: “Family”, “Friends” and “Business”. Using the keypad 12 and selection cursor 22, the user highlights and selects the group “Family”.

As shown in FIG. 2c, the telephone then displays a list of melodies: “melody 1”, “melody 2” and “melody 3” from which the user selects “melody 2”. This option is then associated with the group “Family” such that “melody 2” is played when subsequent incoming calls are received from contacts within the group “Family”.

Referring back to FIG. 2a, in order to store the call handling profile, the phonebook database stored in the memory of the telephone is provided with extra fields: “Group” and “Rule” in columns 3 and 4 of the phonebook database 24 of FIG. 2a respectively.

In this example, the Name field with record “Mum” has a related Group field containing the identifier Family associated with it together with related “Rule” field containing the identifier Melody 2. This means a call from “Mum” will be notified to the user of the telephone by playing Melody 2. Name field records “F. Brown” and “S Smith” have. not been assigned related groups by the user, and therefore the melody played is that of the default melody which is typically set by the manufacturer and may be modified by the user.

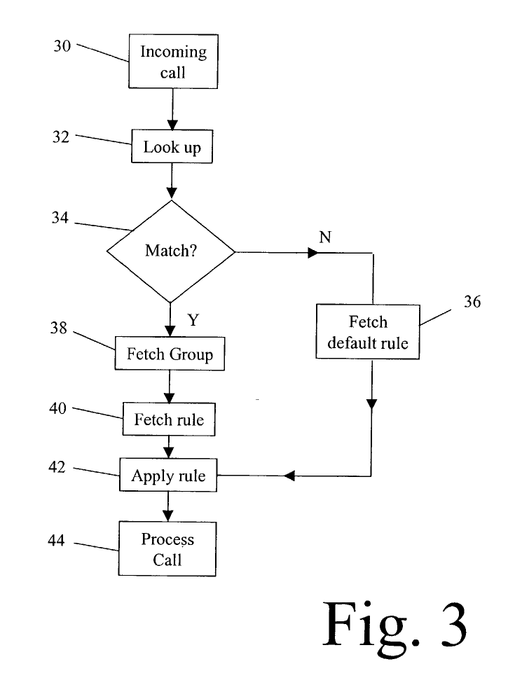

FIG. 3 presents a flow diagram illustrating the steps taken during the aforementioned call handling. The microprocessor 18 of the telephone 10, upon detecting an incoming call (Step 30) receives the caller ID (for example the telephone number of the caller) and performs a look up search (Step 32) in the “Number” fields of the profile database 24 and checks for a matching entry (Step 34). Upon obtaining a match, the corresponding entry in the “Group” field of database 24 is retrieved (Step 38) followed by the associated rule (Step 40). The rule is then applied (Step 42), such as play “Melody 2” as above, and processing of the call (Step 44) continues with the Name and Group of the caller displayed on the telephone's display 14 and “Melody 2” sounded as the ringtone. In the absence of a specified group (Step 34), a default rule is retrieved (Step 36) and applied (Step 42).

The above example employs a phonebook database, however, as will be readily appreciated by the skilled person, there may exist many other ways of configuring a telephone to do the same. Additionally, further examples involving implementation of additional rules associated with a group of contacts are possible. Such additional rules comprising vibrate alert, backlight flash, screen animation or increasing ringtone volume may also be implemented in the profile database 24 with suitable database entries by for example adding extra fields for audible rules, visible rules, and rules relating to backlight or animations on the screen to the database of FIG. 2a.

### EXAMPLE 2

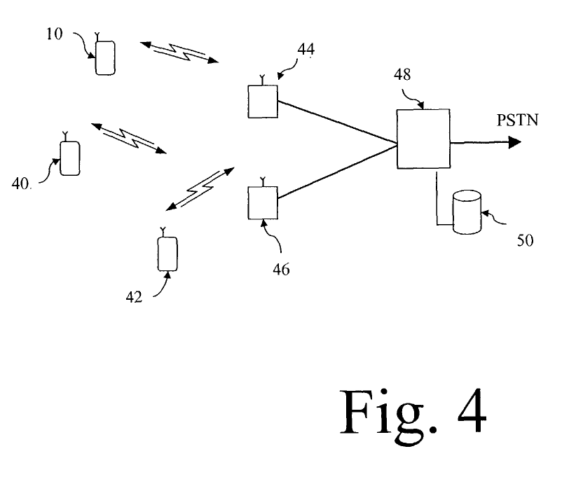

In example 1, the user profile was defined and stored in the mobile telephone, and the rules for handling incoming calls were implemented by the telephone 10. FIG. 4 shows an alternative arrangement wherein a mobile network infrastructure, such as that based on the GSM standard, is used to provide the call handling functionality in the event that a call is made to a telephone for which a call handling profile has been defined.

The network infrastructure consists of a mobile switching station 48 which performs the role of routing and switching calls to and from mobile cellular telephones 10, 40, 42 via base stations 44, 46.

A profile may be created by a user using a telephone as in example 1, however, rather than store the profile locally, it may be uploaded to a server 50 connected to the mobile switching station 48. Then, in the event of a call to a telephone for which a profile has been defined from another telephone, the mobile switching centre may retrieve the profile from the server and provide call handling in accordance with the profile. Such call handling may include rules comprising call barring, call forwarding, messaging (e.g. SMS) and voicemail features; all normally controlled by the mobile switching centre.

### EXAMPLE3

As example 2 except that the user creates a profile on a home computer (not shown) and uploads the profile to the server 50 via the Internet.

In the above examples, methods for defining profiles and handling calls based on such profiles have been described, largely with respect to mobile telephones and associated networks. However, it will be appreciated that such methods are equally applicable to fixed landline telephones and cordless telephones connected to landline networks. Furthermore, such methods are also applicable to calls comprising data transfer such as SMS messaging as well as voice calls.

From a reading of the present disclosure, other modifications will be apparent to the skilled person and may involve other features which are already known in the design, manufacture and use of mobile telephones, mobile communications devices, systems, and component parts thereof, and which may be used instead of or in addition to features already described herein.

1. A method of enabling a user to define a call handling profile for a telephone comprising the steps of:
presenting a plurality of groups of telephone numbers, or identifiers associated therewith, for selection of at least one of them by the user;
presenting a plurality of rules for handling incoming calls for selection of at least one of them by the user; and
associating the or each group selected by the user with the or each rule selected by the user to define the profile.

2. A method of handling a call made to a telephone for which a call handling profile has been defined in accordance with the method of claim 1, the method of handling the call comprising the steps of:
determining whether the call is from a telephone having a telephone number, or identifier associated therewith, contained within one or more of the profile's groups; and
handling the call in accordance with the or each rule associated to that or those groups.

3. A telephone comprising a processor, display and user input means adapted to enable a user of that telephone to define a call handling profile for that telephone by:
displaying on the display a plurality of groups of telephone numbers, or identifiers associated therewith, for selection of at least one of them by the user via the user input means;
displaying on the display a plurality of rules for handling incoming calls for selection of at least one of them by the user via the user input means; and
associating the or each group selected by the user with the or each rule selected by the user to define the call handling profile.

4. A telephone according to claim 3 further comprising a memory connected to the processor for storing the call handling profile.

5. A telephone according to claim 3 or claim 4 adapted to handle an incoming call according to the call handling profile.

6. A telephone according to any of claims 3 to 5 wherein at least two rules associated with different ringing tones are displayed for selection.

7. A telephone according to any of claims 3 to 6 further adapted to transmit the call handling profile to a remote server.

8. A communications system comprising a server operable to receive and store a call handling profile which defines associations between groups of telephone numbers, or identifiers associated therewith, and rules for handling calls from telephones having those telephone numbers or identifiers.

9. A communications system according to claim 8, further comprising call handling means for handling a call by determining whether the call is from a telephone having a telephone number, or identifier associated therewith, contained within one or more of the profile's groups; and to handling the call in accordance with the or each rule associated to that or those groups.

10. A communications system according to claim 8 or claim 9 wherein the rules for handling calls comprise allowing, barring or diverting calls.

11. A communications system according to any of claims 8 to 10, operable to receive and store the call handling profile from a remote telephone.

12. A communications system according to any of claims 8 to 10, operable to receive and store the call handling profile from a remote computer.
